(19) United States
(12) Patent Application Publication
(10) Pub. No.: US 2025/0380839 A1
(43) Pub. Date: Dec. 18, 2025

(54) METHOD AND APPARATUS FOR HEATING/COOKING FOOD ITEMS

(71) Applicant: Robert K. Coughlin, Danville, IN (US)

(72) Inventor: Robert K. Coughlin, Danville, IN (US)

(21) Appl. No.: 19/231,820

(22) Filed: Jun. 9, 2025

Related U.S. Application Data
(60) Provisional application No. 63/659,119, filed on Jun. 12, 2024.

(51) Int. Cl. A47J 43/18; A47J 37/04; A47J 43/28

(52) U.S. Cl. CPC A47J 43/18; A47J 37/049; A47J 43/283

(57) ABSTRACT

A method and apparatus for heating/cooking a food item. The apparatus has an elongate body with a graspable handle and a food support spaced lengthwise of the body from the graspable handle. A guard between the handle and food support impedes heat transfer from a heat generating cooking source to a user's grasping hand while holding a food item on the food support over the heat generating cooking source.

### BACKGROUND OF THE INVENTION

### Cross-Reference to Related Applications

This is a non-provisional application claiming priority to U.S. Provisional Application No. 63/659,119 filed Jun. 12, 2024.

### Field of the Invention

This invention relates to a method and apparatus for heating/cooking food items.

### Background Art

It is common when camping to make an open fire and to cook food items, such as marshmallows, hot dogs, etc., by holding the food items over an open flame. Commonly, thin wire skewers are used to control movement of the food items. The skewers are projected into the food item and held at a spaced location and controllably manipulated over the flame.

Commonly, the skewers are relatively short such that the user's hand grasping the skewer is in close proximity to the flame. This can result in uncomfortable heat exposure and potentially burns.

### SUMMARY OF THE INVENTION

In one form, the invention is directed to a method of heating/cooking a food item. The method includes the steps of: obtaining an apparatus having an elongate body with a graspable handle, a support for the food item spaced lengthwise along the body from the handle, and a guard; engaging the food item with the support; and grasping the handle with a user's hand and through the grasped handle controllably lifting and reorienting the support with the engaged food item to situate the food item in the vicinity of a heat generating cooking source, to thereby heat/cook the food item. The apparatus has a guard on the body that resides between the user's hand grasping the handle and the support. The guard is configured to impede heat transfer between the heat generating cooking source and the user's hand grasping the handle.

In one form, the elongate body has a lengthwise axis. With the user's hand grasping the handle, the user's hand wraps at least partially around the lengthwise axis.

In one form, the graspable handle has an effective diameter. The guard has at least a portion that projects away from the lengthwise axis a distance greater than the effective diameter of the handle.

In one form, the guard has a wall that projects radially away from the elongate body and extends at least partially around the lengthwise axis.

In one form, the guard projects substantially fully around the lengthwise axis.

In one form, the guard has a receptacle into which at least part of the user's hand projects when grasping the handle.

In one form, the support is in the form of a skewer. The food item is a hot dog. The hot dog is engaged by the support by directing the support into the hot dog.

In one form, the invention is directed to the apparatus described above.

### BRIEF DESCRIPTION OF THE DRAWINGS

FIG. 1 is a schematic representation of an apparatus for heating/cooking a food item, according to the invention;

FIG. 2 is a schematic representation of a guard, as shown schematically in FIG. 1, and showing additional details thereof;

FIG. 3 is a fragmentary, perspective view of one exemplary form of the guard, as shown in FIG. 2;

FIG. 4 is a fragmentary, elevation view of another form of guard, as shown schematically in FIG. 1; and

FIG. 5 is a flow diagram representation of a method of heating/cooking a food item, according to the invention.

### DETAILED DESCRIPTION OF THE PREFERRED EMBODIMENT

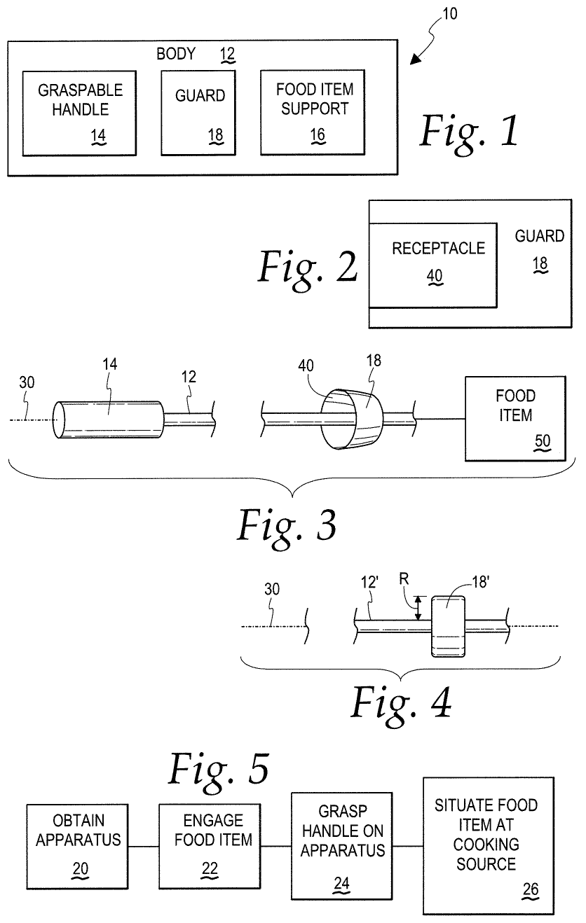

In FIG. 1, an apparatus, according to the present invention, is shown schematically at 10. The apparatus has an elongate body 12 with a graspable handle 14, a food item support 16 spaced lengthwise of the body 12 from the handle 14, and a guard 18.

As shown schematically in flow diagram form in FIG. 5, a food item can be heated/cooked by obtaining the apparatus 10, as shown at block 20.

As shown at block 22, the food item is engaged with the support 16.

As shown at block 24, the user grasps the handle on the apparatus 10 and, as shown at block 26, through manipulation of the handle, controllably lifts and reorients the support with the engaged food item to situate the food item in the vicinity of a heat generating cooking source to thereby heat/cook the food item.

The guard 18 on the body 12 is configured to impede heat transfer between the heat generating cooking source and the user's hand grasping the handle 14.

As shown in one exemplary form in FIG. 3, the body 12 has a lengthwise axis 30. The handle 14 has a generally cylindrical shape around which the user's hand extends in grasping the handle. In doing so, the user's hand wraps at least partially around the axis 30.

The guard 18 may have a multitude of different shapes and may extend partially or fully around the axis 30. Generally, it will have an effective diameter, relative to the axis 30, that is greater than the diameter of the handle 14, whereby it extends radially upwardly to cover/shield at least a portion of the user's grasping hand, as viewed along the axis 30.

The guard 18 in a generic form may extend partially or fully around the axis 30.

As shown in one form in FIG. 2, the guard 18 has a receptacle 40 into which a part of the user's hand grasping the handle projects.

In the FIG. 3 form, within the more general depiction in FIG. 2, the guard 18 has a shape as commonly used on swords to define a mechanical obstruction to objects. Inherently, the structure defining the receptacle 40 will act to impede heat transfer to a degree depending upon its overall shape, size, and its material(s) of construction.

FIG. 4 shows a guard 18′ that projects upwardly from the body 12′ without a discrete receptacle. The guard 18′ may extend partially or fully around the axis 30. The radial projection R may vary, as may its circumferential extent, to partially or fully shield the user's grasping hand, as viewed along the axis 30.

As shown in FIG. 3, the food item 50 may be any food item that is commonly heated/cooked over an open flame, such as the aforementioned marshmallows and hot dogs. The food item support 16 may have the aforementioned skewer shape or may be any support structure, such as a basket, a clampable wall structure, etc.

The foregoing disclosure of specific embodiments is intended to be illustrative of the broad concepts comprehended by the invention.

1. A method of heating/cooking a food item, the method comprising the steps of:
obtaining an apparatus comprising an elongate body with a graspable handle, a support for the food item spaced lengthwise along the body from the handle, and a guard;
engaging the food item with the support; and
grasping the handle with a user's hand and through the grasped handle controllably lifting and reorienting the support with the engaged food item to situate the food item in the vicinity of a heat generating cooking source, to thereby heat/cook the food item,
wherein the apparatus comprises a guard on the body that resides between the user's hand grasping the handle and the support,
the guard configured to impede heat transfer between the heat generating cooking source and the user's hand grasping the handle.

2. The method of heating/cooking a food item according to claim 1 wherein the elongate body has a lengthwise axis and with the user's hand grasping the handle the user's hand wraps at least partially around the lengthwise axis.

3. The method of heating/cooking a food item according to claim 2 wherein the graspable handle has an effective diameter and the guard has at least a portion that projects away from the lengthwise axis a distance greater than the effective diameter of the handle.

4. The method of heating/cooking a food item according to claim 2 wherein the guard comprises a wall that projects radially away from the elongate body and extends at least partially around the lengthwise axis.

5. The method of heating/cooking a food item according to claim 4 wherein the guard projects substantially fully around the lengthwise axis.

6. The method of heating/cooking a food item according to claim 4 wherein the guard defines a receptacle into which at least part of the user's hand projects when grasping the handle.

7. The method of heating/cooking a food item according to claim 1 wherein the support is in the form of a skewer, the food item is a hot dog, and the hot dog is engaged by the support by directing the support into the hot dog.

8. The apparatus in claim 1.
